(19) United States
(12) Patent Application Publication
(10) Pub. No.: US 2016/0113043 A1
(43) Pub. Date: Apr. 21, 2016

(54) Vehicle Gateway Module Configured to Provide Wireless Hotspot

(71) Applicant: Lear Corporation, Southfield, MI (US)

(72) Inventors: Thomas M. O'Brien, Troy, MI (US); Jason G. Bauman, Birmingham, MI (US); Gerard L. Grabowski, Brownstown, MI (US); Stephen M. Humphrey, Livonia, MI (US)

(21) Appl. No.: 14/514,529

(22) Filed: Oct. 15, 2014

(51) Int. Cl. H04W 76/02; H04L 29/08; B60R 16/023

(52) U.S. Cl. CPC H04W 76/02; B60R 16/023; H04L 67/12; H04W 88/16

(57) ABSTRACT

A vehicle gateway module is configured to communicate over vehicle networks connected to the gateway module with vehicle devices connected to the vehicle networks. The gateway module has a cellular data link which provides a direct connection from the gateway module to the Internet and a wireless data link which provides a direct connection from the gateway module to an area within the vehicle whereby the cellular data link in conjunction with the wireless data link establish an Internet hotspot for a mobile device within the vehicle.

### TECHNICAL FIELD

The present invention relates to vehicle gateway modules.

### BACKGROUND

A vehicle gateway module enables communication between vehicle devices operating on vehicle networks.

### SUMMARY

An object of the present invention includes a vehicle gateway module configured to provide an Internet or wireless hotspot.

Another object of the present invention includes a vehicle gateway module having cellular data network connectivity in conjunction with wireless connectivity for establishing an Internet or wireless hotspot within the vehicle.

In carrying out at least one of the above and other objects, the present invention provides a system for a vehicle. The system includes a gateway module configured to communicate over vehicle networks connected to the gateway module with vehicle devices connected to the vehicle networks. The gateway module has a cellular data link which provides a direct connection from the gateway module to the Internet and a wireless data link which provides a direct connection from the gateway module to an area within the vehicle whereby the cellular data link in conjunction with the wireless data link establish an Internet hotspot for a mobile device within the vehicle.

In an embodiment, the cellular data link is one of a 3G data link and a 4G data link.

In an embodiment, the wireless data link is one of a WiFi™ wireless data link and a Bluetooth™ wireless data link.

In an embodiment, the gateway module includes two wireless data links with one of the wireless data links being a WiFi™ wireless data link and the other wireless data link being a Bluetooth™ wireless data link.

Further, in carrying out at least one of the above and other objects, the present invention provides a method for a vehicle. The method includes providing a gateway module configured to communicate over vehicle networks connected to the gateway module with vehicle devices connected to the vehicle networks. The method further includes establishing an Internet hotspot within the vehicle for use by a mobile device within the vehicle by providing a cellular data link from the gateway module to the Internet and a wireless data link from the gateway module to an area within the vehicle.

In an embodiment, the method further includes communicating between the mobile device and a remote entity connected to the Internet via the cellular data link and the wireless data link.

In an embodiment, the method further includes communicating between a vehicle device connected to a vehicle network connected to the gateway module, the mobile device, and a remote entity connected to the Internet via the gateway module, the cellular data link, and the wireless data link.

In an embodiment, the method further includes communicating a communication from the mobile device to a remote entity connected to the Internet via the wireless data link and the cellular data link, and communicating a communication from the remote entity to a vehicle device connected to a vehicle network connected to the gateway module via the cellular data link and the gateway module in response to the communication communicated from the mobile device.

In an embodiment, the method further includes remotely accessing, via the cellular data link, by a remote entity connected to the Internet, a vehicle device connected to a vehicle network connected to the gateway module in response to a request communicated from the mobile device to the remote entity via the wireless data link and the cellular data link.

Also, in carrying out at least one of the above and other objects, the present invention provides another method for a vehicle. This method includes providing a gateway module configured to communicate over vehicle networks connected to the gateway module with vehicle devices connected to the vehicle networks. This method further includes communicating between a remote entity connected to the Internet and a mobile device within the vehicle via a cellular data link of the gateway module and a wireless link of the gateway module in which the cellular data link provides a direct connection from the gateway module to the Internet and the wireless link provides a direct connection from the gateway module to an area within the vehicle.

### BRIEF DESCRIPTION OF THE DRAWINGS

FIG. 1 illustrates a block diagram of a vehicle gateway module in accordance with an embodiment of the present invention;

FIG. 2 illustrates a schematic drawing of a vehicle having the gateway module in accordance with an embodiment of the present invention; and

FIG. 3 illustrates a block diagram of an environment including the gateway module in communication with vehicle devices connected to vehicle networks connected to the gateway module, a mobile device within the vehicle connected to the gateway module via a wireless network, and a remote entity connected to the gateway module via a cellular data network in accordance with an embodiment of the present invention.

### DETAILED DESCRIPTION

Detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

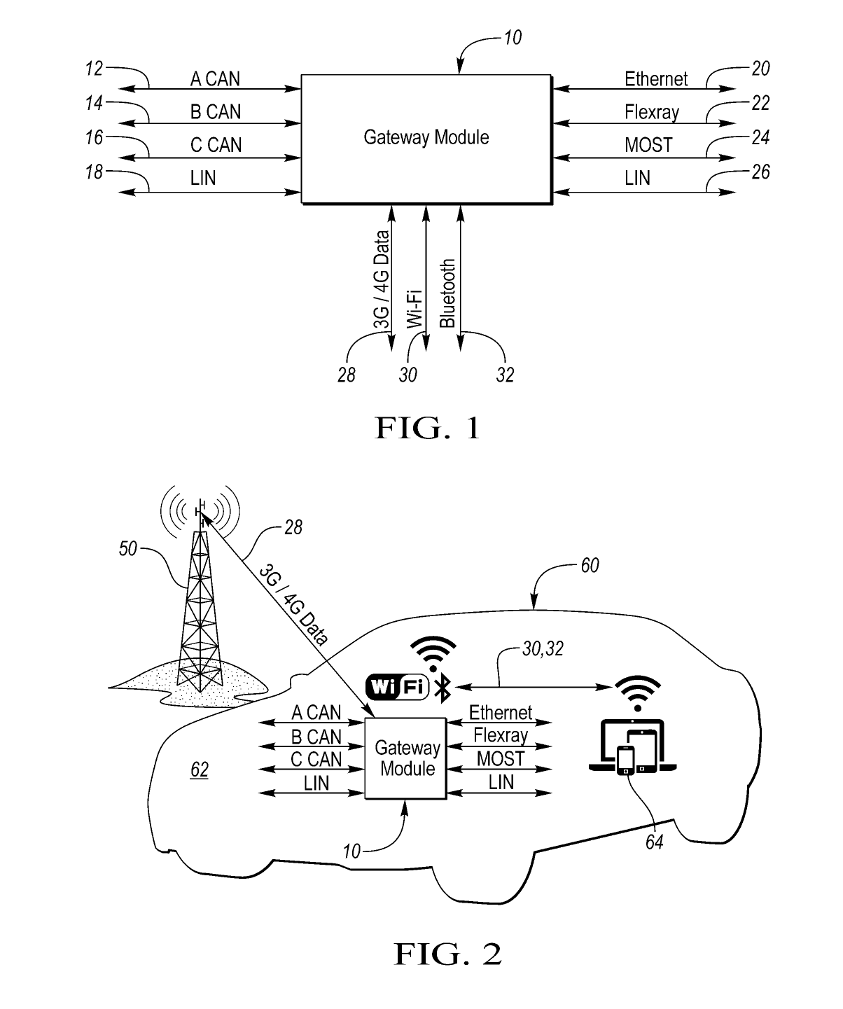

Referring now to FIG. 1, a vehicle gateway module 10 in accordance with an embodiment of the present invention is shown. Gateway module 10 is mountable within a vehicle and is configured to enable communication between and with vehicle devices operating on one or more vehicle networks. Such vehicle devices include controllers configured to control associated vehicle components and sensors configured to monitor associated vehicle components. A set of vehicle devices may operate on a vehicle network. Gateway module 10 and the set of vehicle devices are connected to one another through the vehicle network. The vehicle devices use the vehicle network to exchange information with one another and/or gateway module 10. The exchanged information may be in regards to the control and/or monitoring of the vehicle components associated with the vehicle devices.

Similarly, a second set of vehicle devices may operate on a second vehicle network, a third set of vehicle devices may operate on a third vehicle network, etc. Gateway module 10 and the second and third sets of vehicle devices are connected to one another through the second and third vehicle networks, respectively. In each case, vehicle devices operating on a vehicle network use that network to exchange information with one another and/or gateway module 10.

Gateway module 10 enables communication between vehicle devices operating on different vehicle networks. Gateway module 10 enables such communication in either case of the vehicle networks being of the same type or of different types. Vehicle networks of the same type use the same communication protocol whereas vehicle networks of different types use different communication protocols from one another.

For example, as shown in FIG. 1, gateway module 10 is connected to a plurality of vehicle networks 12, 14, 16, 18, 20, 22, 24, and 26. The vehicle networks include a first Controller Area Network (CAN) 12, a second CAN 14, a third CAN 16, a first Local Interconnect Network (LIN) 18, an Ethernet network 20, a FlexRay™ network 22, a Media Oriented Systems Transport (MOST) network 24, and a second LIN 26.

Each vehicle network may connect with none or one or more vehicle devices operating on the network. For instance, first CAN 12 may be a vehicle powertrain CAN bus including engine, transmission, and brake controllers as well as other directly related sensors and actuators. Second CAN 14 may be a comfort or body CAN bus used to run comfort systems such as power windows, seat memory, tire pressure, etc. First LIN 18 may be an application LIN bus for applications such as an air conditioner or wiper control. MOST network 24 may be an infotainment MOST bus.

Vehicle networks 12, 14, 16, 18, 20, 22, 24, and 26 are either of the same type and use the same communication protocol or of different types and use different communication protocols. For instance, CANs 12, 14, and 16 are of the same type and use the same communication protocol. Likewise, LINs 18 and 26 are of the same type and use the same communication protocol. However, the communication protocol used by CANs 12, 14, and 16 is different than the communication protocol used by LINSs 18 and 26. Each of the other networks 20, 22, and 24 use their own communication protocol different than the communication protocols of any of the other networks. As such, gateway module 10 is configured to function as a translator in enabling communication between vehicle devices operating on vehicle networks employing different communication protocols. In general, gateway module 10 manages network traffic on vehicle networks connected to the gateway module.

Gateway module 10 further includes an embedded cellular data link 28. Cellular data link 28 provides gateway module 10 with cellular data network connectivity. Cellular data link 28 such as a 3G or 4G data link is a direct connection between gateway module 10 and an external Internet access node of an Internet access provider. The Internet access node is in communication with the Internet. As such, gateway module 10 is configured to use a cellular data network for Internet connectivity and such connectivity is “always on.”

Gateway module 10 further includes at least one embedded wireless link 30 and 32. In this embodiment, gateway module 10 includes first and second wireless links 30 and 32. Each wireless link 30, 32 provides gateway module 10 with short range wireless connectivity. For example, first wireless link 30 is a WiFi™ link and second wireless link 32 is a Bluetooth™ wireless link.

Referring now to FIG. 2, with continual reference to FIG. 1, a schematic drawing of a vehicle 60 having gateway module 10 in accordance with an embodiment of the present invention is shown. The schematic drawing of FIG. 2 is intended to illustrate that gateway module 10 is configured to establish an Internet or wireless access hotspot 62 within vehicle 60. Hotspot 62 provides mobile devices 64 of vehicle occupants with Internet connectivity via gateway module 10.

In particular, cellular data link 28 provides a direct cellular connection between gateway module 10 and an Internet access node 50 in communication with the Internet. Wireless links 30 and/or 32 provide a direct wireless connection between gateway module 10 and mobile devices 64. As a result, communication between mobile devices 64 and the Internet can take place via cellular data link 28 and wireless links 30 and/or 32. In this regard, cellular data link 28 and wireless links 30 and/or 32 provide cellular data network connectivity in conjunction with wireless connectivity, respectively, for establishing hotspot 62 within vehicle 60.

Additionally, other communication paths can be established from the hotspot functionality: gateway module to cellular internet; gateway module to vehicle; gateway module to mobile devices; and gateway module hotspot.

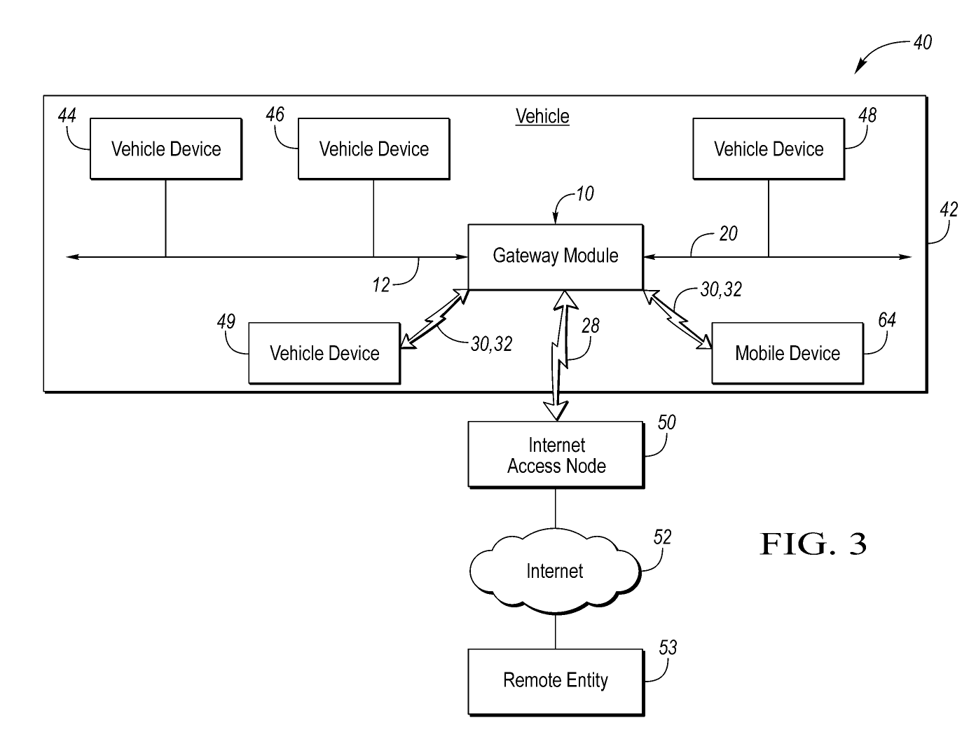

Referring now to FIG. 3, with continual reference to FIGS. 1 and 2, a block diagram of an environment 40 including gateway module 10 in accordance with an embodiment of the present invention is shown.

As shown in FIG. 3, gateway module 10 is a component of a vehicle 42. For simplicity, gateway module 10 is shown in FIG. 3 as being connected just to CAN 12 and Ethernet network 20. CAN 12 and Ethernet network 20 are of different types and employ different communication protocols as described above. A first vehicle device 44 and a second vehicle device 46 operate on CAN 12. A third vehicle device 48 operates on Ethernet network 20. As described above, gateway module 10 enables communication between devices 44 and 46 on CAN 12 and device 48 on Ethernet network 20 with one another and/or gateway module 10.

In environment 40, gateway module 10 is in communication with vehicle devices 44, 46, and 48 connected to vehicle networks 12 and 20 connected to the gateway module. Gateway module 10 is also in communication with a remote entity 53 via cellular data link 28 and with a mobile device 64 within vehicle 60 via wireless data link 30 and/or 32. As used herein, a remote entity is an entity (i.e., provider, connection) remotely located far enough away from gateway module 10 that communication with gateway module 10 can only take place via cellular data link 28 and not via wireless links 30 or 32.

In particular, cellular data link 28 provides a direct connection between gateway module 10 and an Internet access node 50 in communication with the Internet 52. Remote entity 53 is independently connected to the Internet 52. As such, gateway module 10 is in communication with remote entity 53 via cellular data link 28. Wireless data link 30 and/or 32 provides a direct connection between gateway module 10 and mobile devices 64. As such, gateway module 10 is in communication with mobile devices 64 via wireless data link 30 and/or 32. As gateway module 10 is in communication with remote entity 53 via cellular data link 28 and with mobile device 64 via wireless data link 30 and/or 32, mobile device 64 and remote entity 53 are in communication with one another via cellular data link 28, wireless data link 30 and/or 32, and gateway module 10. Accordingly, communication between mobile device 64 and remote entity 53 can take place via cellular data link 28, wireless data link 30 and/or 32, and gateway module 10.

As described, gateway module 10 is also in communication with devices 44 and 46 on CAN 12 and device 48 on Ethernet network 20. Accordingly, communication between any of devices 44, 46, and 48 and mobile device 64 and remote entity 53 can take place via cellular data link 28, wireless data link 30 and/or 32, and gateway module 10.

In an embodiment, remote entity 53 communicates with a vehicle device, such as vehicle device 48, via cellular data link 28 and gateway module 10 in conjunction with communicating with mobile device 64 via cellular data link 28 and wireless data link 30 and/or 32. For instance, remote entity 53 communicates with vehicle device 48 to remotely control the vehicle device in response to a command regarding same communicated from mobile device 64 to remote entity 53. Such remote control functions include remote start, vehicle unlock, setting temperature, etc. As another example, remote entity 53 communicates with vehicle device 48 to obtain diagnostic information from the vehicle device in response to a request or an authorization regarding same communicated from mobile device 64 to remote entity 53. Such diagnostic information includes traction battery conditions, tire pressure, fault conditions, etc. As another example, remote entity 53 communicates with vehicle device 48 for some purpose and communicates some sort of notification regarding same to mobile device 64.

In an embodiment, remote entity 53 communicates re-flash software to gateway module 10 via cellular data link 28 in response to receiving a request regarding same communicated from mobile device 64 via cellular data link 28 and wireless data link 30 and/or 32. The re-flash software is for receipt by one or more of vehicle devices 44, 46, and 48 such as device 44. The re-flash software is communicated from remote entity 53 to recipient device 44 over vehicle network 12 via gateway module 10 and cellular data link 28. In this manner, the re-flash software is directly downloaded “over the air” to the recipient device 44 in response to a request from mobile device 64.

In an embodiment, a fourth vehicle device 49 of vehicle 42 is connected to gateway module 10 by only a wireless link 30 and/or 32. Vehicle device 49 is a controller of any number of body, chassis, and/or engine functions that is permanently mounted in vehicle 42, but which communicates with other vehicle devices 44, 46, and/or 48 wirelessly (via gateway module 10).

As described, cellular data link 28 of gateway module 10 is an “always on” external data connection and wireless link 30 and/or 32 is an always on internal data connection. As a result, gateway module 10 provides an always on Internet or wireless hotspot accessible to vehicle occupant mobile devices 64.

As gateway module 10 is a central vehicle hub the gateway module 10 has access to the vehicle networks connected to the gateway module and can thereby manage cyber security, diagnostics, over-the-air re-flashing, and the like. Therefore, in addition to the benefits provided by an in-vehicle Internet or wireless hotspot, it is advantageous that gateway module 10 provides the Internet or wireless hotspot.

While exemplary embodiments are described above, it is not intended that these embodiments describe all possible forms of the present invention. Rather, the words used in the specification are words of description rather than limitation, and it is understood that various changes may be made without departing from the spirit and scope of the present invention. Additionally, the features of various implementing embodiments may be combined to form further embodiments of the present invention.

What is claimed is:

1. A system for a vehicle comprising:
a gateway module configured to communicate over vehicle networks connected to the gateway module with vehicle devices connected to the vehicle networks, the gateway module having a cellular data link which provides a direct connection from the gateway module to the Internet and a wireless data link which provides a direct connection from the gateway module to an area within the vehicle whereby the cellular data link in conjunction with the wireless data link establish an Internet hotspot for a mobile device within the vehicle.

2. The system of claim 1 wherein:
communication between the mobile device and a remote entity connected to the Internet is enabled via the cellular data link and the wireless data link.

3. The system of claim 1 wherein:
communication between a vehicle device connected to a vehicle network connected to the gateway module, the mobile device, and a remote entity connected to the Internet is enabled via the gateway module, the cellular data link, and the wireless data link.

4. The system of claim 1 wherein:
the cellular data link is one of a 3G data link and a 4G data link.

5. The system of claim 1 wherein:
the wireless data link is one of a WiFi™ wireless data link and a Bluetooth™ wireless data link.

6. The system of claim 5 wherein:
the gateway module further includes a second wireless data link which provides a direct connection between the gateway module and a mobile device within the vehicle, the second wireless data link being the other one of a WiFi™ data wireless link and a Bluetooth™ data wireless link.

7. The system of claim 1 wherein:
the vehicle networks are respectively one of a Controller Area Network (CAN), a Local Interconnect Network (LIN), an Ethernet network, a FlexRay™ network, and a Media Oriented Systems Transport (MOST) network.

8. A method for a vehicle comprising:
providing a gateway module configured to communicate over vehicle networks connected to the gateway module with vehicle devices connected to the vehicle networks; and
establishing an Internet hotspot within the vehicle for use by a mobile device within the vehicle by providing a cellular data link from the gateway module to the Internet and a wireless data link from the gateway module to an area within the vehicle.

9. The method of claim 8 further comprising:
communicating between the mobile device and a remote entity connected to the Internet via the cellular data link and the wireless data link.

10. The method of claim 8 further comprising:
communicating between a vehicle device connected to a vehicle network connected to the gateway module, the mobile device, and a remote entity connected to the Internet via the gateway module, the cellular data link, and the wireless data link.

11. The method of claim 8 further comprising:
communicating a communication from the mobile device to a remote entity connected to the Internet via the wireless data link and the cellular data link; and
communicating a communication from the remote entity to a vehicle device connected to a vehicle network connected to the gateway module via the cellular data link and the gateway module in response to the communication communicated from the mobile device.

12. The method of claim 8 further comprising:
remotely accessing, via the cellular data link, by a remote entity connected to the Internet, a vehicle device connected to a vehicle network connected to the gateway module in response to a request communicated from the mobile device to the remote entity via the wireless data link and the cellular data link.

13. The method of claim 8 wherein:
the cellular data link is one of a 3G data link and a 4G data link, and the wireless data link is one of a WiFi™ wireless data link and a Bluetooth™ wireless data link.

14. The method of claim 8 further comprising:
communicating between a vehicle device connected to the gateway module via the wireless data link and a vehicle device connected to the gateway module via one of the vehicle networks.

15. A method for a vehicle comprising:
providing a gateway module configured to communicate over vehicle networks connected to the gateway module with vehicle devices connected to the vehicle networks; and
communicating between a remote entity connected to the Internet and a mobile device within the vehicle via a cellular data link of the gateway module and a wireless data link of the gateway module in which the cellular data link provides a direct connection from the gateway module to the Internet and the wireless link provides a direct connection from the gateway module to an area within the vehicle.

16. The method of claim 15 further comprising:
communicating between a vehicle device connected to a vehicle network connected to the gateway module, the mobile device, and the remote entity via the gateway module, the cellular data link, and the wireless data link.

17. The method of claim 15 further comprising:
communicating a communication from the remote entity to a vehicle device connected to a vehicle network connected to the gateway module via the cellular data link and the gateway module in response to a communication communicated from the mobile device to the remote entity via the wireless data link and the cellular data link.

18. The method of claim 15 further comprising:
remotely accessing, via the cellular data link, by the remote entity, a vehicle device connected to a vehicle network connected to the gateway module in response to a request communicated from the mobile device to the remote entity via the wireless data link and the cellular data link.

19. The method of claim 15 wherein:
the cellular data link is one of a 3G data link and a 4G data link.

20. The method of claim 15 wherein:
the wireless data link is one of a WiFi™ wireless data link and a Bluetooth™ wireless data link.
